(19) United States
(12) Patent Application Publication
(10) Pub. No.: US 2018/0316234 A1
(43) Pub. Date: Nov. 1, 2018

(54) MOTOR

(71) Applicant: MABUCHI MOTOR CO., LTD., Matsudo City, Chiba (JP)

(72) Inventors: Masaaki Ikawa, Matsudo City, Chiba (JP); Wataru SAKURAI, Matsudo City, Chiba (JP)

(21) Appl. No.: 15/533,987

(22) PCT Filed: Nov. 18, 2015
(86) PCT No.: PCT/JP2015/082431

§ 371 Date: Jun. 7, 2017

(30) Foreign Application Priority Data
Dec. 19, 2014 (JP) 2014-257740

(51) Int. Cl. H02K 1/30; H02K 1/14; H02K 1/27

(52) U.S. Cl. CPC H02K 1/30; H02K 1/146; H02K 29/03; H02K 2213/03; H02K 1/278

(57) ABSTRACT

A rotor includes a rotor core and one or more magnets. The rotor core includes magnet supporters radially formed around a rotating shaft. The magnet includes a supported part supported by the magnet supporter and a projection projecting from the magnet supporter in an axial direction of the rotating shaft, The rotor core and the supported parts arranged annularly form a first generation part that generates a cogging torque of a first waveform, and the projections arranged annularly form a second generation part that generates a second cogging torque that differs in phase from the cogging torque of the first waveform.

### BACKGROUND OF THE INVENTION

1. Field of the Invention

The present invention relates to motors.

2. Description of the Related Art

Motors are used as driving sources for various devices end products. Uneven torque in a motor can occur for various reasons. Uneven torque can generate vibration and noise as well as inhibiting smooth rotation of the motor. One of the causes for generating uneven torque is cogging. Cogging is a phenomenon that could occur even while an electric current is not induced in a coil. Cogging is torque variation primarily generated by magnetic interaction between the core and the magnet.

As a technology to reduce a cogging torque, there is proposed a rotor comprising: a first configuration part in which N-poles and S-poles of magnets are alternately and circumferentially arranged on the outer circumferential surface of a rotor core; and a second configuration part in which only N-poles or only S-poles of magnets are arranged in axial alignment with the same poles of the magnets of the first configuration part and in which salient poles are provided in the rotor core and function as the opposite poles of the magnets, said only N-poles or only S-poles and the salient poles being alternately arranged in the circumferential direction of the rotor core (see patent document 1).

### RELATED ART DOCUMENT

[patent document 1] JP2010-142006

However, the arrangement of the magnets and shape of the rotor core in the aforementioned rotor differ in the first configuration part and in the second configuration part, resulting in a complicated manufacturing process. Additionally, the magnets are entirely exposed on the surface of the rotor core so that there is room for improvement in terms of prevention of scattering associated with the rotation of the rotor.

### SUMMARY OF THE INVENTION

The embodiments of the present invention addresses the aforementioned issue, and a purpose thereof is to provide a rotor of a novel configuration capable of reducing a cogging torque.

A motor according to an embodiment of the present invention includes: a tube stator including a stator core having a plurality of teeth, and wirings wound around the plurality of teeth respectively; and a rotor provided at the center of the stator. The rotor includes: a rotor core; and one or more magnets. The rotor core includes magnet supporters radically formed around a rotating shaft. The magnet includes a supported part reported by the magnet supporter and a projection projecting from the magnet supporter in an axial direction of the rotating shaft. The rotor core and the plurality of supported parts arranged annularly form a first generation part that generates a cogging torque of a first waveform, and the projections are arranged annularly and form a second generation part that generates a second cogging torque that differs in phase from the cogging torque of the first waveform. The stator core is configured to face the supported part and the projection of the magnet in a radial direction of the stator. The term “annularly arranged” encompasses cases where a plurality of members are arranged at intervals and substantially annularly as well as cases where the members are completely continuous.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a sectional view of the brushless motor according to the first embodiment;

FIG. 2 is a sectional view along A-A of the motor shown in FIG. 1;

FIG. 3 is a sectional view along B-B of the motor shown in FIG. 1;

FIG. 4A is a top view of the rotor core according to the first embodiment, and FIG. 4B is a top view schematically showing that the magnets are supported in the holders of the rotor core shown in FIG. 4A;

FIG. 5 is a schematic view of a model of the non-IPM part analyzed;

FIG. 6 is a schematic view of a model of the IPM part analyzed;

FIG. 7 is a graph showing a relationship between the mechanical angle and the cogging torque occurring when the rotor is composed only of the non-IPM part shown in FIG. 5;

FIG. 8A is a schematic diagram of the rotor in which the thickness of the IPM part is 25% the total thickness of the rotor, FIG. 8B is a schematic diagram of the rotor in which the thickness of the IPM part is 50% the total thickness of the rotor, FIG. 8C is a schematic diagram of the rotor in which the thickness of the IPM part is 75% the total thickness of the rotor, and FIG. 8D is a schematic diagram of the rotor in which the thickness of the IPM part is 100% the total thickness of the rotor;

FIG. 9 is a graph showing a relationship between the mechanical angle and the cogging torque occurring when the axial length of the IPM part shown in FIG. 6 is 25% the total thickness of the rotor;

FIG. 10 is a graph showing a relationship between the mechanical angle and the cogging torque occurring when the axial length of the IPM part is 50% the total thickness of the rotor;

FIG. 11 is a graph showing a relationship between the mechanical angle and the cogging torque occurring when the axial length of the IPM part is 75% the total thickness of the rotor;

FIG. 12 is a graph showing a relationship between the mechanical angle and the cogging torque occurring when the axial length of the IPM part is 100% the total thickness of the rotor;

FIG. 13 is a graph showing a relationship between the axial length of the IPM part and the magnetic flux density in the teeth;

FIG. 14 is a graph showing a relationship between the axial length of the IPM part and the cogging torque;

FIG. 15A is a top view of the rotor core according to the second embodiment, and FIG. 15B is a top view schematically showing that the magnets are supported in the holders of the rotor core shown in FIG. 15A;

FIG. 16 is a graph showing a relationship between the mechanical angle and the cogging torque occurring when the rotor is composed only of the IPM part in the second embodiment;

FIG. 17 is a graph showing a relationship between the mechanical angle and the cogging torque occurring when the IPM part is of a thickness 75% the total thickness of rotor;

FIG. 18 is a graph showing a relationship between the mechanical angle and the cogging torque occurring when the IPM part is of a thickness 50% the total thickness of rotor;

FIG. 19 is a graph showing a relationship between the mechanical angle and the cogging torque occurring when the IPM part is of a thickness 25% the total thickness of rotor;

FIG. 20A is a top view of the rotor core according to the third embodiment, and FIG. 20B is a top view schematically showing that the magnets are supported in the holders of the rotor core shown in FIG. 20A;

FIG. 21 is a graph showing a relationship between the mechanical angle and the cogging torque occurring when the rotor is composed only of the IPM part in the third embodiment;

FIG. 22 is a graph showing a relationship between the mechanical angle and the cogging torque occurring when the IPM part is of a thickness 75% the total thickness of rotor;

FIG. 23 is a graph showing a relationship between the mechanical angle and the cogging torque occurring when the IPM part is of a thickness 50% the total thickness of rotor;

FIG. 24 is a graph showing a relationship between the mechanical angle and the cogging torque occurring when the IPM part is of a thickness 25% the total thickness of rotor;

FIG. 25 is a sectional view of the motor according to the fourth embodiment;

FIG. 26 is a sectional view showing the schematic structure of the rotor according to the sixth embodiment;

FIG. 27 is a sectional view of the motor according to the seventh embodiment;

FIG. 28 is a sectional view of the motor according to the eighth embodiment;

FIG. 29 is a sectional view of the brushless motor according to a variation of the first embodiment;

FIG. 30 is a sectional view of the brushless motor according to a another variation of the first embodiment;

FIG. 31 is a graph showing a relationship between the mechanical angle and the cogging torque in the motor according to the fifth embodiment;

FIG. 32 is a graph showing a relationship between the mechanical angle and the cogging torque in the motor according to the sixth embodiment;

FIG. 33 is a schematic sectional view of the rotor according to a variation; and

FIG. 34A is a schematic sectional view of the rotor according to another variation, and FIG. 34B is a sectional view along C-C in FIG. 34A.

### DETAILED DESCRIPTION OF THE INVENTION

A motor according to an embodiment of the present invention includes: a tube stator including a stator core having a plurality of teeth, and wirings wound around the plurality of teeth respectively; and a rotor provided at the center of the stator. The rotor includes: a rotor core; and one or more magnets. The rotor core includes magnet supporters radially formed around a rotating shaft. The magnet includes a supported part supported by the magnet supporter and a projection projecting from the magnet supporter in an axial direction of the rotating shaft. The rotor core and the plurality of supported parts arranged annularly form a first generation part that generates a cogging torque of a first waveform, and the projections are arranged annularly and form a second generation part that generates a second cogging torque that differs in phase from the cogging torque of the first waveform. The stator core is configured to face the supported part and the projection of the magnet in a radial direction of the stator. The term “annularly arranged” encompasses cases where a plurality of members are arranged at intervals and substantially annularly as well as cases where the members are completely continuous.

According to the embodiment, the rotor, in conjunction with the stator, can generate two cogging torques that differ in phase so that the cogging torque occurring when the rotor is built in the motor is reduced, as compared to a case where the cogging torques generated by the respective generation parts are aligned in phase. Also, the magnetic flux emanating from the supported part and the projection of the magnet can be guided efficiently to the stator core.

The magnet may include a first projection that projects from the magnet supporter in one axial direction of the rotating shaft, and a second projection that projects from the magnet supporter in the other axial direction of the rotating shaft. This realizes smooth rotation of the motor.

The magnet may be provided with the supported part at one end of the magnet in an axial direction of the rotating shaft. This realizes smooth rotation of the motor.

The magnet may be provided with two supported parts spaced apart from each other at respective ends of the magnet in an axial direction of the rotating shaft. The projection may be provided between the two supported parts. This realizes smooth rotation of the motor.

Given that an axial length of the magnet is denoted by L and an axial thickness of the magnet supporter is denoted by T, the following expression (1) may be met,

0.2<T/L<0.75 (1).

This can reduce the total cogging torque in the rotor and prevent the magnetic flux density from dropping excessively.

A plurality of magnets may be provided. The plurality of magnets may be annularly arranged in a Halbach array. This can reduce the thickness of the yoke portion of the rotor core so that the weight of the rotor can be reduced.

An incision that communicates the magnet supporter with a space outside may be formed in the outer circumference of the rotor core. This inhibits the magnetic flux emanating from the magnets from short-circuiting (magnetic short-circulating) in the rotor core.

Another embodiment of the present invention also relates to a motor. The motor includes: a tube (or cylindrical) stator including a stator core having a plurality of teeth, and wirings wound around the plurality of teeth respectively; and a rotor provided at the center of the stator. The rotor includes: a rotor core; a polar anisotropic ring magnet provided on the outer circumference of the rotor core; and a magnetic ring provided on the outer circumference of the ring magnet and smaller in width in an axial direction than the ring magnet. An area in the rotor in which the rotor core, the ring magnet, and the magnetic ring overlap in radial direction of the rotor core form a first generation part that generates a cogging torque of a first waveform. An area in the rotor which the ring magnet and the magnetic ring do not overlap in a radial direction of the rotor core form a second generation part that generates a second cogging torque that differs in phase from the cogging torque of the first waveform. The stator core is configured to face the first generation part and the second generation part in a radial direction of the stator.

According to the embodiment, the rotor, in conjunction with the stator, can generate two cogging torques that differ in phase so that the cogging torque occurring when the rotor is built in the motor is reduced, as compared to a case where the cogging torques generated by the respective generation parts are aligned in phase. Also, the magnetic flux emanating from the first generation part and the second generation part can be guided efficiently to the stator core.

A stator core may be configured such that an inner diameter of an area facing the projection is smaller than an inner diameter of an area facing the supported part. This can reduce the distance between the projection of the magnet and the stator core.

Optional combinations of the aforementioned constituting elements, and implementations of the invention in the form of methods, apparatuses, and systems may also be practiced as additional modes of the present invention. According to the present embodiment, the cogging torque can be reduced.

A description will be given of an embodiment of the present invention with reference to the drawings. Like numeral represent like elements so that the description will be omitted accordingly. The structure described below is by way of example only and does not limit the scope of the invention. A brushless motor of inner rotor type is described below by way of an example.

### First Embodiment

### [Brushless Motor]

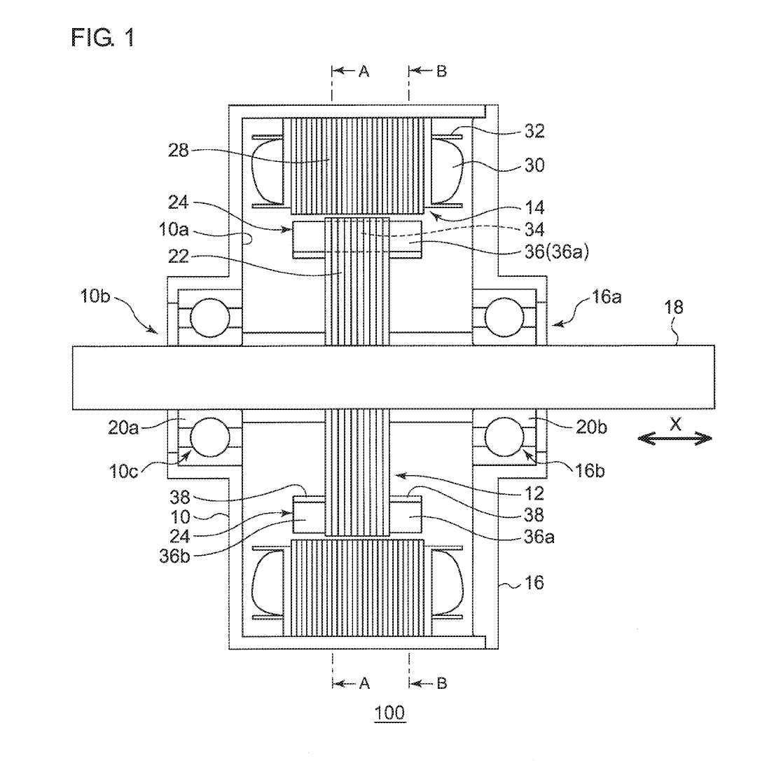

FIG. 1 is a sectional view of the brushless motor according to the first embodiment. A brushless motor (hereinafter, also referred to as “motor”) 100 according to the first embodiment includes a housing 10, a rotor 12, a stator 14, and an end bell 16.

The housing 10 is a cylindrical member having a bottom part 10a. A hole 10b is formed at the center so that a rotating shaft 18 can extend therethrough, and a recess 10c for supporting a bearing 20a is formed near the hole 10b. The end bell 16 is a plate-shaped member and is formed with a hole 16a at the center so that the rotating shaft 18 can extend therethrough and with a recess 16b near the hole 16a to support a bearing 20b. The housing 10 and the end bell 16 constitute a casing of the motor 100.

### [Rotor]

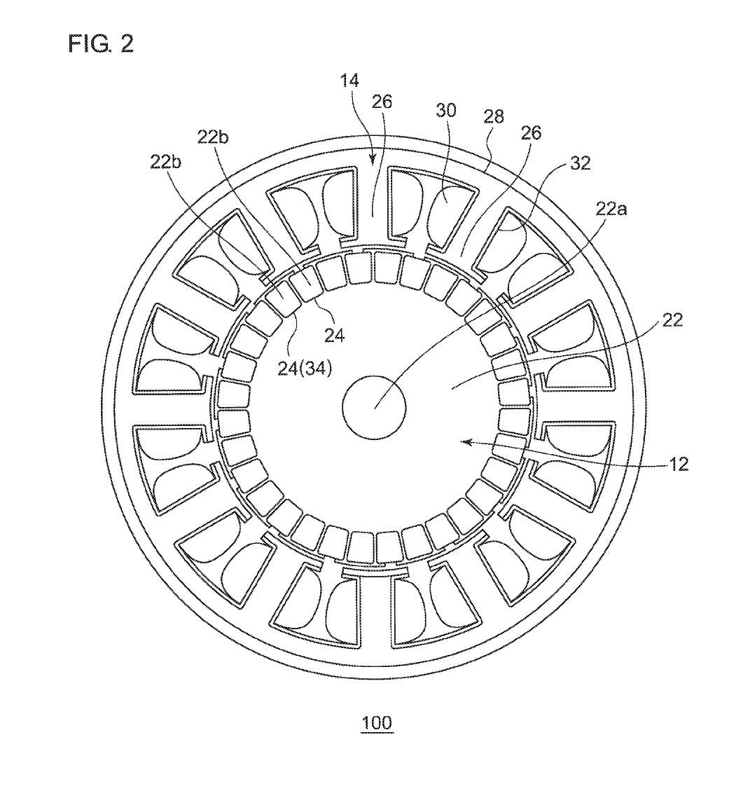

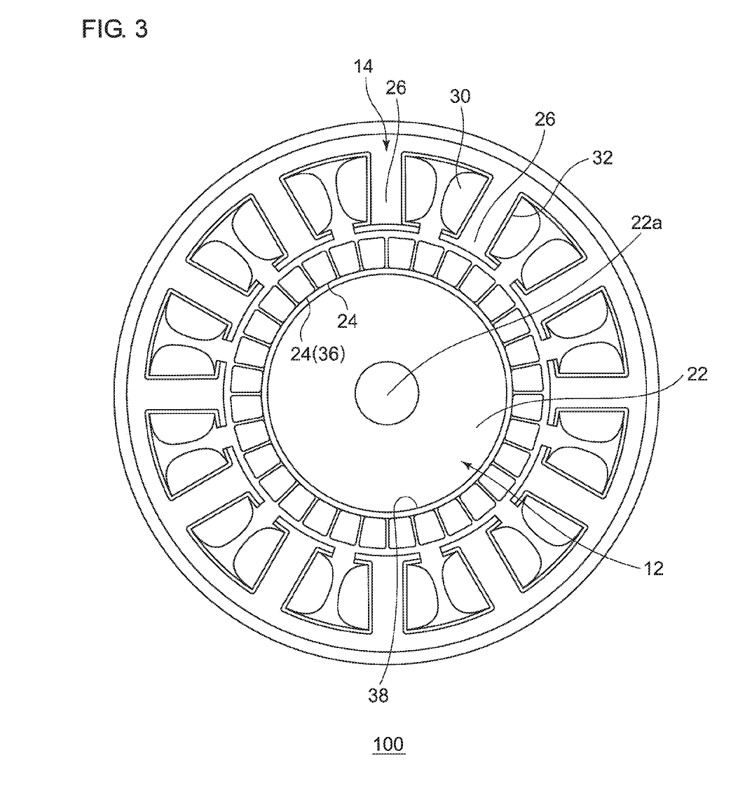

FIG. 2 is a sectional view along A-A of the motor shown in FIG. 1. FIG. 3 is a sectional view along B-B of the motor shown in FIG. 1. In FIGS. 2 and 3, hatching in omitted.

The rotor 12 includes an annular or substantially circular rotor core 22, a back yoke 38, and a plurality of magnets 24. A through hole 22a, in which the rotating shaft 18 is inserted and fixed, is formed at the center of the rotor core 22. Also, the rotor core 22 has a plurality of magnet holders 22b in which the magnets 24 are inserted and supported. The magnet holders 22b also function as magnet supporters. The magnets 24 are columnar members having substantially trapezoidal cross sections and conforming to the shapes of the magnet holders 22b. The back yoke 38 is a ring-shaped (thin annular) member and is preferably formed of a soft magnetic metal material. More specifically, the back yoke 38 is formed of pure iron or an iron-based alloy containing Si.

The members described above are assembled in sequence. More specifically, each of a total of 32 magnets 24 is fitted into the corresponding magnet holder 22b, and the rotating shaft 18 is inserted into the through hole 22a of the rotor core 22.

The ring-shaped back yoke 38 is adhesively bonded to the rotor core 22 and the magnets 24. The back yoke 38 may alternatively have a cup shape. In this case, the back yoke 38 is fixed to the rotor core 22 and the magnets 24 by using an adhesive or a rib.

In this embodiment, an example in which the ring-shaped back yoke 38 is used in the rotor 12 is described by way of example. Alternatively, the back yoke 38 may not be used. Further, the rotor core 22 may be a laminated core of a thickness substantially identical to that of the stator core 28.

### [Stator]

A detailed description will be given of the structure of the stator 14. The stator 14 includes a cylindrical stator core 28 having a plurality of teeth 26 and wirings 30 wound around the plurality of teeth 26 respectively. The stator core 28 is configured by laminating a plurality of plate-shaped stator yokes. The stator yoke is manufactured by stamping out a silicon steel sheet (e.g., a non-oriented electromagnetic steel sheet) or a cold-rolled steel sheet into a predetermined shape by press-forming. The stator yoke is configured such that a plurality of (12, in this embodiment) tooth 26 are formed to extend from the inner circumference of an annular portion toward the center.

An insulator 32 is attached to each of the teeth 26. Then, a conductor is wound around the insulator 32 for each of the teeth 26 so as to form a wirings 30. The rotor 12 is placed at the center of the stator 14 that has been completed through the above processes.

### [Rotor Core]

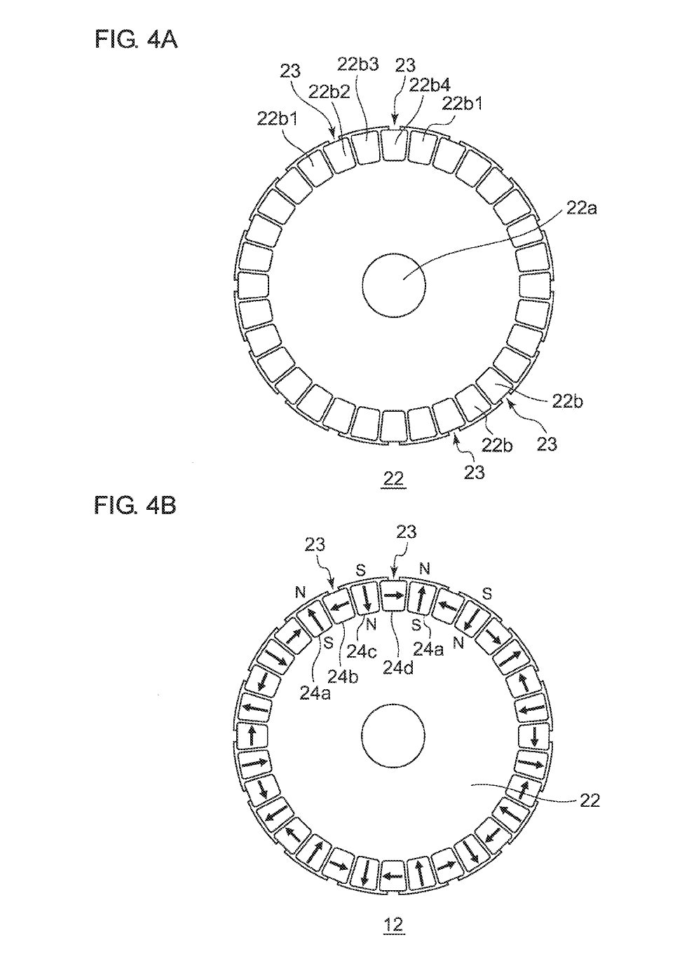

FIG. 4A is a top view of the rotor core according to the first embodiment, and FIG. 4B is a top view schematically showing that the magnets are supported in the holders of the rotor core shown in FIG. 4A. The rotor core 22 is configured by laminating a plurality of plate-shaped members. Each of the plurality of plate-shaped members is manufactured by stamping out a silicon steel sheet (e.g., a non-oriented electromagnetic steel sheet) or a cold-rolled steel sheet into a predetermined shape as shown in FIG. 4A by press-forming. The magnet holders 22b are radially formed around the rotating shaft of the rotor core 22.

As shown in FIG. 4B, four types of magnets that differ in the orientation of magnetic poles are circumferentially arranged in a sequential order. A radial magnet 24a is accommodated in a magnet holder 22b1 so that the enter circumferential surface presents an N pole and the inner circumferential surface presents an S pole. A circumferential magnet 24b adjacent to the radial magnet 24a is accommodated in a magnet holder 22b2 such that the side facing the radial magnet 24a presents an N pole and the side facing a racial magnet 24c described below presents an S pole. The radial magnet 24c adjacent to the circumferential magnet 24b is accommodated in a magnet holder 22b3 such that the outer circumferential surface presents an S pole and the inner circumferential surface presents an N pole. A circumferential magnet 24d adjacent to the radial magnet 24c is accommodated in a magnet holder 22b4 such that the side facing the radial magnet 24c presents an S pole and the side facing the radial magnet 24a presents an N pole.

Consequently, the rotor 12 according to the embodiment functions as a magnet having a total of 16 poles including 8 N poles and 8 S poles alternately arranged on the outer circumference of the rotor 12. The 32 magnets according to the embodiment are annularly arranged such that 8 groups, each formed by the magnets 24a-24d, form a Halbach array. This can reduce the thickness of the yoke portion (back yoke 38) of the rotor core 22 so that the weight of the rotor 12 can reduced. Also, the size of the motor can be reduced by providing the bearings further inside in the axial direction.

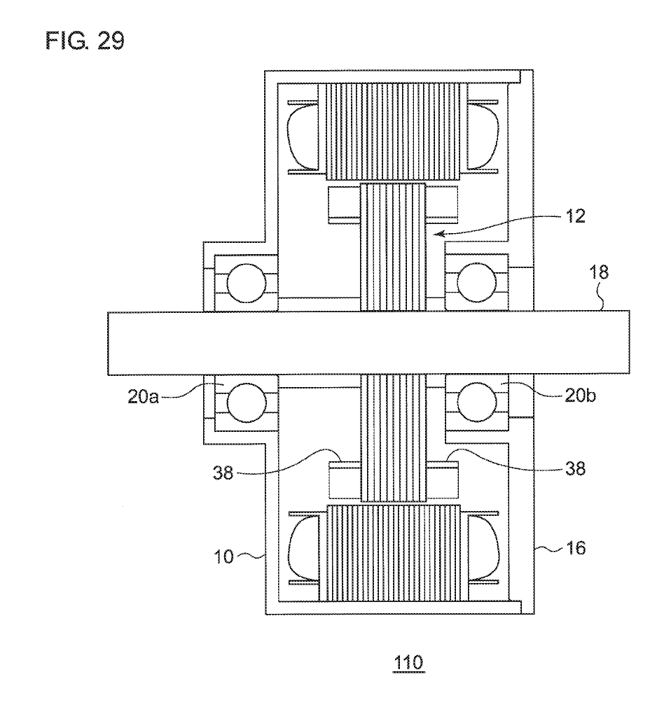

FIG. 29 is a sectional view of the brushless motor according to a variation of the first embodiment. The schematic structure of a motor 110 shown in FIG. 29 is substantially identical to that of the motor 100 shown in FIG. 1. A difference is that the bearing 20b is provided in a space at the center of the ring-shaped back yoke 38 of the rotor 12. This makes it unnecessary to provide the recess 16b of the end bell 16 shown in FIG. 1 and the bearing 20b can be provided so as to be interior to the end bell 16. Therefore, the size and thickness of the motor 110 can be reduced. By providing the bearing 20a inside the housing 10, the size and thickness of the motor 110 can be further reduced.

For example, the magnets 24 may be bonded magnets or sintered magnets. A bonded magnet is a magnet formed by kneading a magnetic material with a rubber or resin material and then subjecting the resulting material to injection molding or compression molding. By a using a bonded magnet, a high-precision C face (inclined plane) or R face is obtained without having to perform any postprocessing. On the other hand, a sintered magnet is a magnet formed by sintering a powdered magnetic material at high temperature. The sintered magnet is more likely to improve the residual magnetic flux density than the bonded magnet is. However, in order to have a high-precision C face or R race, the postprocessing is often required.

### [Cogging Torque]

In ordinary brushless motors, it is difficult to prevent a cogging torque from occurring due to magnetic interaction between the stator and the rotor including magnets. After a careful study to reduce a cogging torque as much as possible, however, we have found out that the cogging torque characteristics can be made to vary in the axial direction of the rotor by, for example, causing parts of the magnets to project from the magnet holders of the rotor core in the axial direction.

As shown in FIGS. 1 through 3, the rotor 12 according to the embodiment is configured such that the magnet 24 includes a supported part 34 accommodated in and supported by the magnet holder 22b and a projection 36 projecting from the magnet holder 22b in the axial direction of the rotating shaft. Therefore, the magnetic field between the stator core 28 and the rotor core 22 supporting the supported part 34 differs significantly in its behavior from the magnetic field between the stator core 28 and the projection 36.

Thus, the rotor core 22 and the plurality of supported parts 34 arranged annularly form a first generation part that generates a cogging torque of a first waveform. The plurality of projections 36 arranged annularly form a second generation part that generates a second cogging torque that differs in phase from the cogging torque of the first waveform.

In conjunction with the stator 14, the rotor 12 configured as described above can generate two cogging torques that differ in phase so that the cogging torque occurring when the rotor is built in the motor is reduced, as compared to a case where the cogging torques generated by the respective generation parts are aligned in phase.

As shown in FIG. 1, the magnet 24 according to the embodiment includes a first projection 36a that projects from the magnet holder 22b in one axial direction X of the rotating shaft 18, and a second projection 36b that projects from the magnet holder 22b in the other axial direction X of the rotating shaft. This realizes smooth rotation of the motor.

The first generation part is configured by the supported part 34 of the magnet 24 accommodated in the magnet holder 22b and so can be viewed as a so-called Interior Permanent Magnet (IPM) part. Meanwhile, the second generation part is configured by the projection 36 of the magnet 24 projecting from the magnet holder 22b and so can be viewed as a non-IPM part. The laminated part of the rotor core 22 is included in the IPM part and the back yoke 38 is included in the non-IPM part. A description will be given hereinafter of how the cogging torque and magnetic flux density of the motor vary depending on the proportion between the IPM part and the non-IPM part, by showing simulation results. Commercially available magnetic field analysis software was used for the simulation.

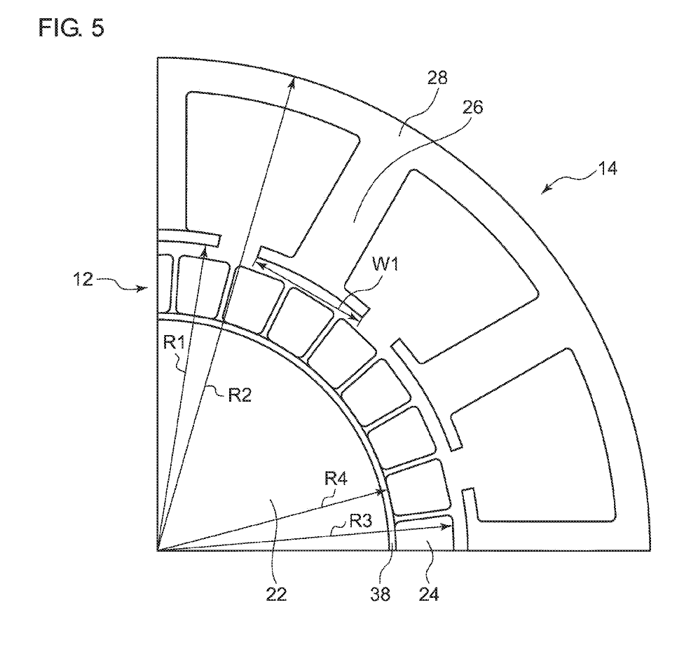

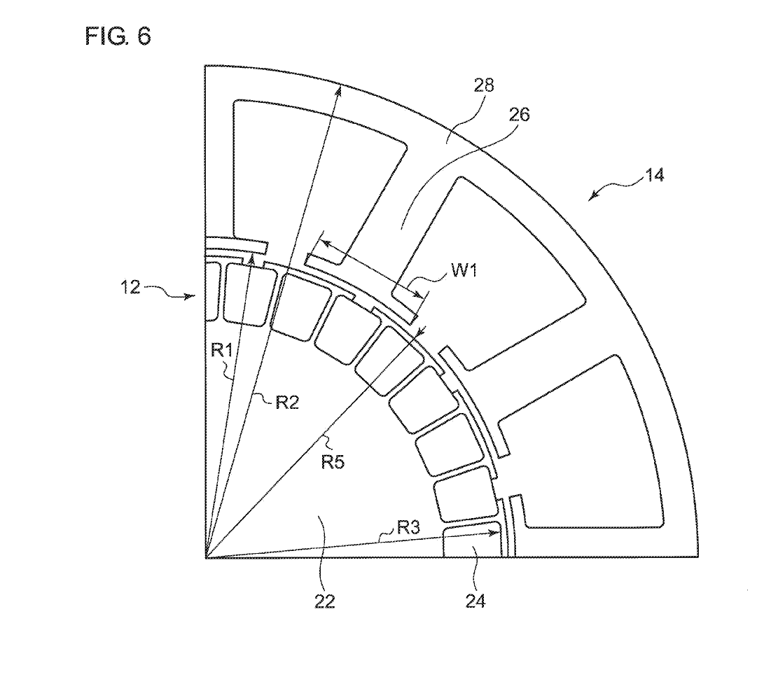

FIG. 5 is a schematic view of a model of the non-IPM part analyzed. FIG. 6 is s schematic view of a model of the IPM part analyzed. The models shown in FIGS. 5 and 6 used in the simulation are of ¼ the size of the actual unit is this circumferential direction, i.e., the models represent 90° arc-shaped segments extending in the circumferential direction of the rotor 12 and the stator 14. The models are of ½ the size of the actual unit in the axial direction: i.e., the thickness in the axial direction is half that of the rotor 12 and the stator 14 shown in FIG 1. Overall, the models are of ⅛ the size of the actual unit.

Examples of parameters in FIGS. 5 and 6 will be given. The inner diameter R1 of the stator core 28 is 12.8 mm and the outer diameter R2 is 20.55 mm. The distance R3 from the center to the outer circumference of the magnets 24 is 12.35 mm, and the outer diameter R4 of the back yoke 38 is 9.9 mm. The outer diameter R5 of the rotor core 22 in the IPM part (see FIG. 6) is 12.6 mm. The circumferential width W1 of the teeth 26 of the stator core 28 is 4.85 mm. The thickness of the stator core 28, the magnets 24, and the rotor 12 in the axial direction is 5 mm. The thickness of the rotor 12 in the axial direction includes the thickness of the rotor core 22 and the back yoke 38.

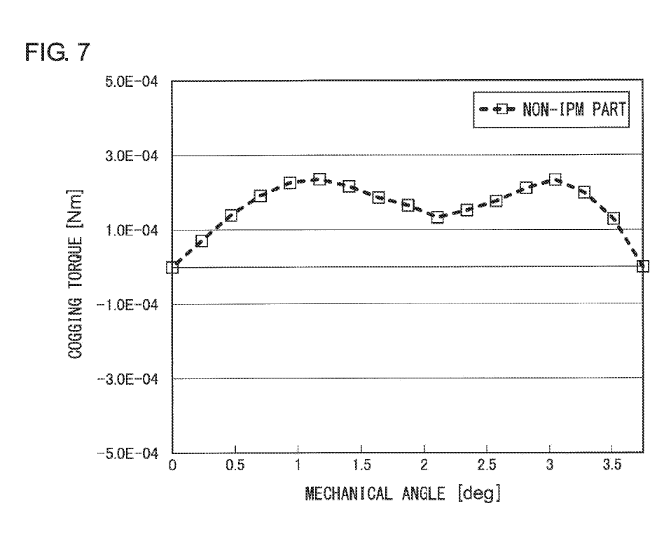

FIG. 7 is a graph showing a relationship between the mechanical angle and the cogging torque occurring when the rotor is composed only of the non-IPM part shown in FIG. 5. In the motor 100 according to this embodiment, the rotor includes 16 magnetic poles and the stator includes 12 magnetic poles. Therefore, the basic order of the cogging torque is 48 and the half-cycle is 3.75 [deg] in mechanical angle. Hereinafter, the characteristics of cogging torque shown in FIG. 7 (hereinafter, may be referred to as “reference cogging torque characteristics”) will serve as a reference.

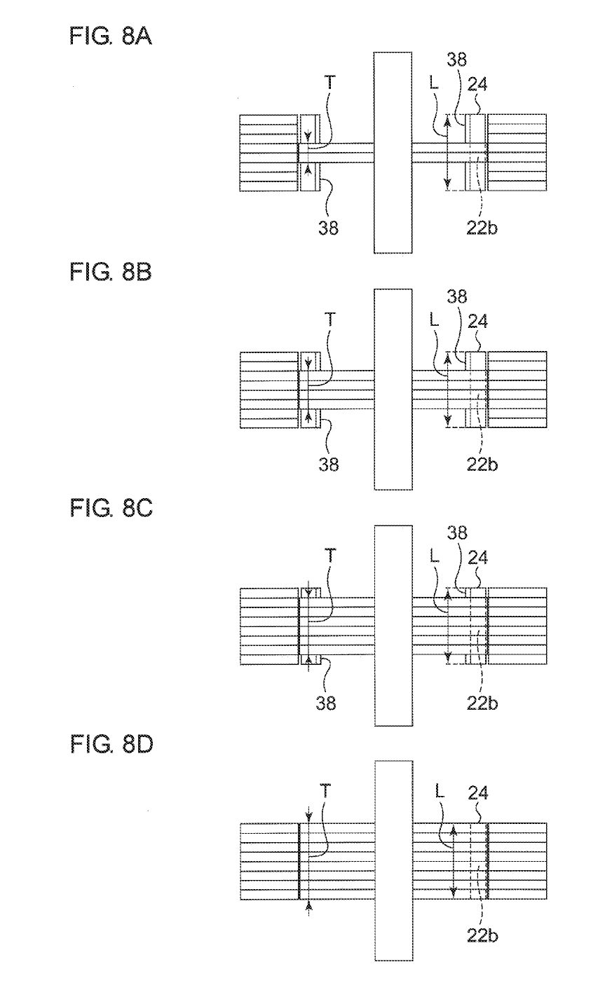

FIG. 8A is a schematic diagram of the rotor in which the thickness of the IPM part is 25% the total thickness of the rotor, FIG. 8B is a schematic diagram of the rotor in which the thickness of the IPM part is 50% the total thickness of the rotor, FIG. 8C is a schematic diagram of the rotor in which the thickness of the IPM part is 75% the total thickness of the rotor, and FIG. 8D is a schematic diagram of the rotor in which the thickness of the IPM part is 100% the total thickness of the rotor. Referring to FIGS. 8A-8D, the axial length of the magnets 24 (total thickness of the rotor) is denoted by L, and the axial thickness of the magnet holder 22b is denoted by T.

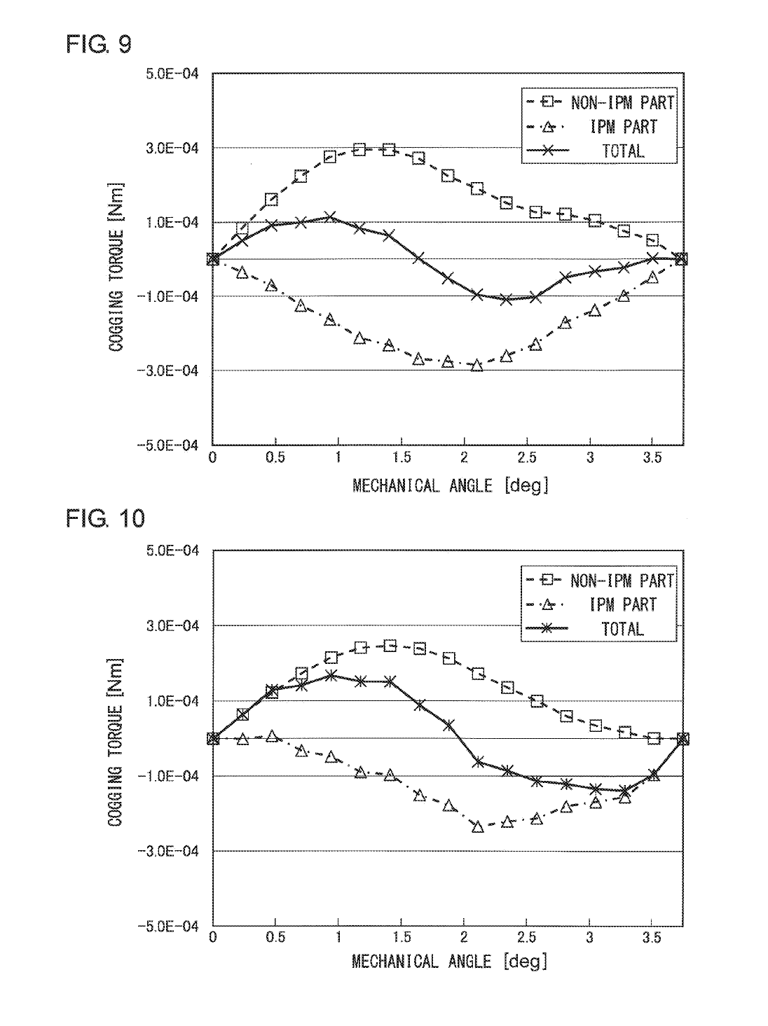

FIG. 9 is a graph showing a relationship between the mechanical angle and the cogging torque occurring when the axial length of the IPM part shown in FIG. 6 is 25% the total thickness of the rotor. As shown in FIG. 9, the cogging torque characteristics of the non-IPM part are characterized by a generally larger cogging torque as compared to the reference cogging torque characteristics shown in FIG. 7. Meanwhile, the phase of the cogging torque in the IPM part is substantially opposite to that of the non-IPM part. For this reason, totaling the cogging torque generated in the non-IPM part and the cogging torque generated in the IPM part, the absolute value (maximum peak value) of the total cogging torque is smaller than that of the reference cogging torque characteristics shown in FIG. 7.

FIG. 10 is a graph showing a relationship between the mechanical angle and the cogging torque occurring when the axial length of the IPM part is 50% the total thickness of the rotor. As shown in FIG. 10, the cogging torque characteristics of the non-IPM part exhibit generally similar values as the reference torque characteristics shown in FIG. 7. Meanwhile, the phase of the cogging torque in the IPM is significantly shifted from that of the non-IPM part. For this reason, totaling the cogging torque generated in the non-IPM part and the cogging torque generated in the IPM part, the absolute value (maximum peak value) of the resulting cogging torque is smaller than that of the reference cogging torque characteristics shown in FIG. 7.

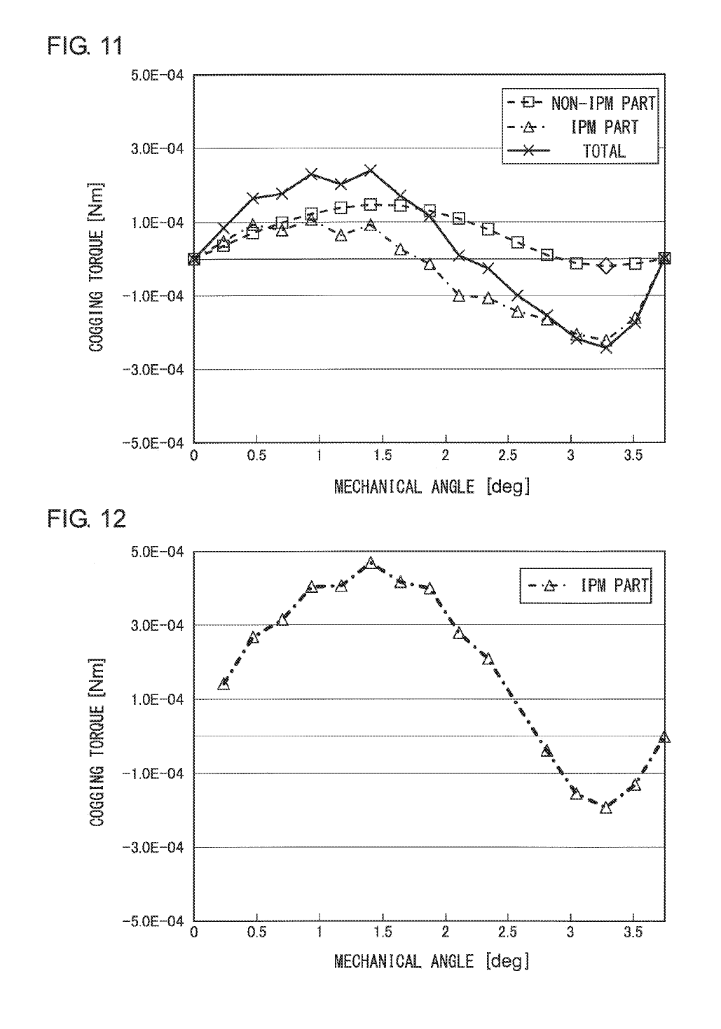

FIG. 11 is a graph showing a relationship between the mechanical angle and the cogging torque occurring when the axial length of the IPM part is 75% the total thickness of the rotor. As shown in FIG. 11, the cogging torque characteristics of the non-IPM part exhibits generally smaller values than the reference torque characteristics shown in FIG. 7. Further, the cogging torque of the IPM part is also of generally smaller values than the reference cogging torque characteristics shown in FIG. 7. However, the phase of the non-IPM part and that of the IPM part are not shifted so much. For this reason, totaling the cogging torque generated in the non-IPM part and the cogging torque generated in the IPM part, the absolute value (maximum peak value) of the resulting cogging torque is relatively larger than that of the reference cogging torque characteristics show in FIG. 7.

FIG. 12 is a graph showing a relationship between the mechanical angle and the cogging torque occurring when the axial length of the IPM part is 100% the total thickness of the rotor. As shown in FIG. 12, the cogging torque characteristics of the IPM part exhibit still larger absolute values (maximum peak values) then the reference cogging torque characteristics shown in FIG. 7.

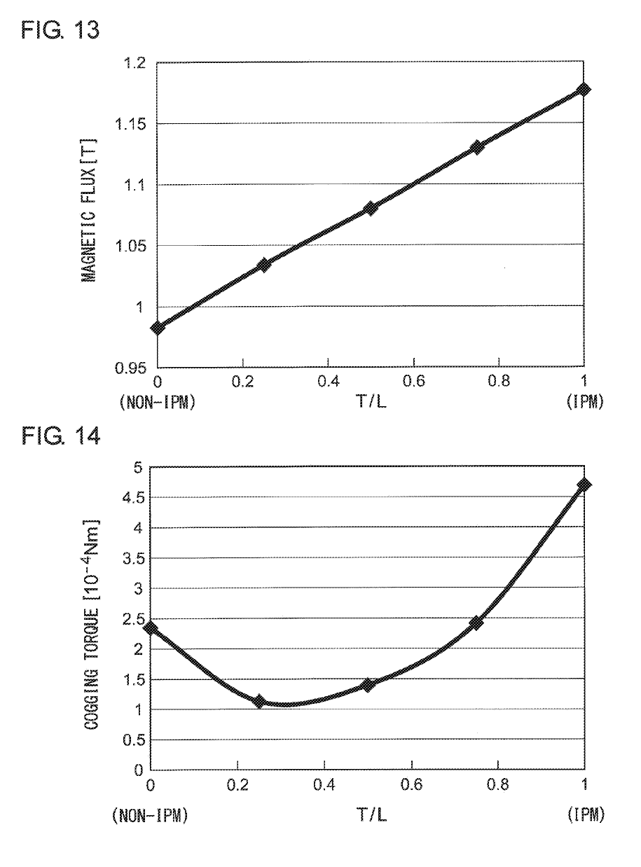

FIG. 13 is a graph showing a relationship between the axial length of the IPM part and the magnetic flux density of the teeth. FIG. 14 is a graph showing a relationship between the axial length of the IPM part and the cogging torque.

As shown in FIG. 13, the magnetic flux density in the arm portion of the stator core increases as the axial length of the IPM part increases. Therefore, a high proportion of the IPM part is preferable in terms of the magnetic flux density. Meanwhile, a high proportion of the IPM part results in an increase in the cogging torque as shown in FIG. 14 and so is not preferable in terms of the cogging torque.

Therefore, given that the axial length of the magnet 24 is denoted by L and the axial thickness of the magnet holder 22b is denoted by T, it is preferable that the rotor 12 according to the embodiment meet a relationship

0.2<T/L<0.75 (1).

More preferably, the rotor meets a relationship 0.25<T/L<0.75. This can reduce the total cogging torque in the rotor and prevent the are magnetic flux density from dropping excessively.

As shown in FIG. 4A, an incision 23 that communicates the magnet holder 22b with a space outside is formed in the outer circumference of the rotor core 22 according to the embodiment. Given that the magnets are arranged in a Halbach array shown in FIG. 4B, the incision 23 is formed in the magnet holders 22b2 and 22b4 where the circumferential magnets 24b and 24d are accommodated. This inhibits the magnetic flux emanating from the magnets from short-circuiting (magnetic short-circuiting) in the rotor core 22.

Further, as shown is FIG. 1, the stator core 28 according to the embodiment is configured to face the supported part 34 and the projection 36 of each of the magnets 24 in the radial direction of the stator 14. This can efficiently guide the magnetic flux emanating from the supported part 34 and the projection 36 of the magnets to the stator core 28.

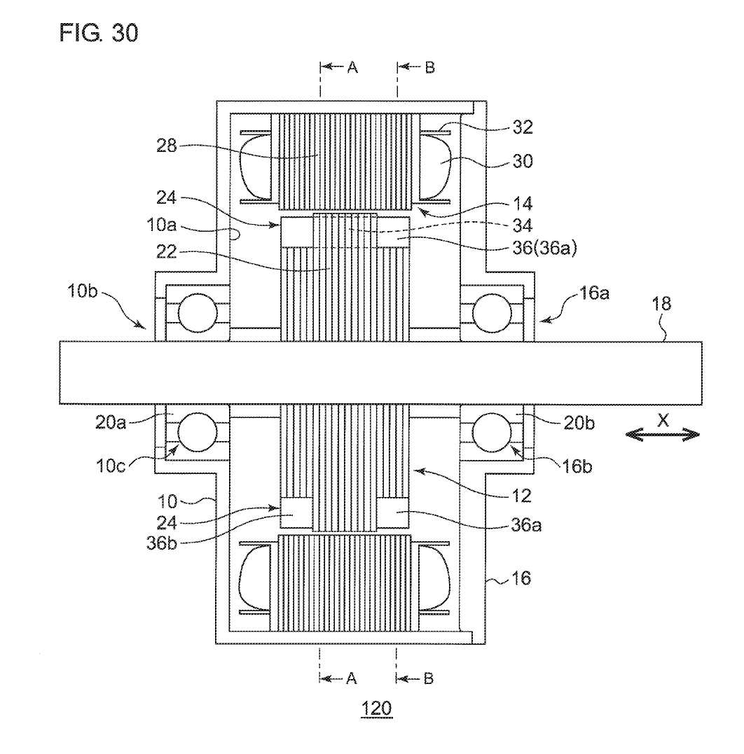

FIG. 30 is a sectional view of the brushless motor according to another variation of the first embodiment. A motor 120 shown in FIG. 30 differs from a from the motor 100 shown in FIG. 1 in that the back yoke 38 is not used and the rotor core 22 is laminated as far as the projections 36 of the magnets 24. Totaling the cogging torque generated in the non-IPM part and the cogging torque generated in the IPM part, the absolute value (maximum peak value) of the cogging torque is smaller than that of the reference cogging torque characteristics shown in FIG. 7 as in the foregoing cases.

### Second Embodiment

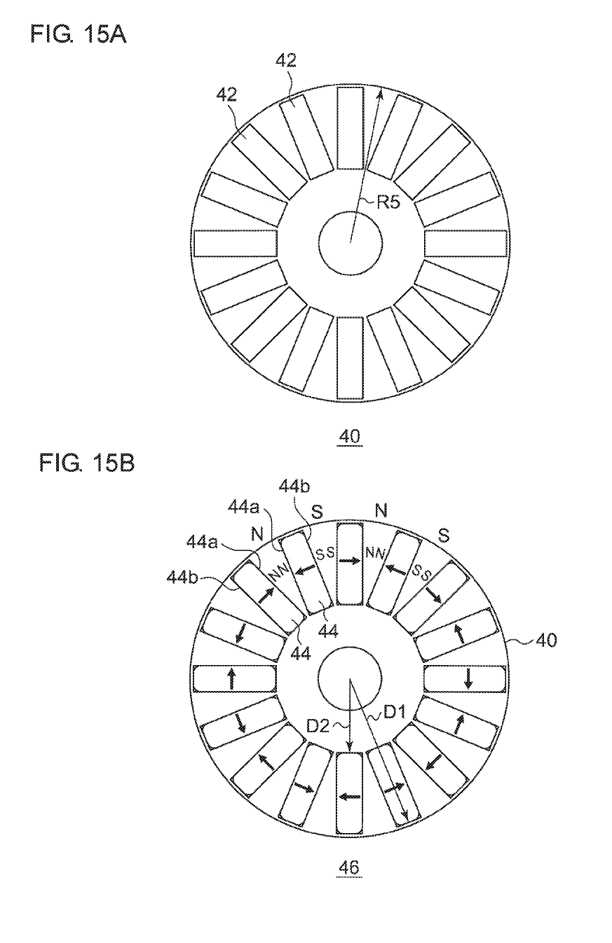

FIG. 15A is a top view of the rotor core according to the second embodiment, and FIG. 15B is a top view schematically showing that the magnets are supported in the holders of the rotor core shown in FIG. 15A. A rotor core 40 is manufactured similarly as the rotor core 22. Magnet holders 42 are radially formed around the rotating shaft of the rotor core 40.

As shown in FIG. 15B, each of magnets 44 has an N pole or an S pole on a main surface 44a (44b) facing the adjacent magnet. The magnets 44 are accommodated in the magnet holders 42 such that the main surfaces of adjacent magnets facing each other have the same pole. In other words, magnets of two types that differ in the orientation of the magnetic poles are alternately arranged in the circumferential direction. Consequently, a rotor 46 according to the embodiment functions an a magnet having 16 poles in total including 8 N poles and 8 S poles alternately arranged on the outer circumference of the rotor 46. The magnets 44 are columnar members having a substantially rectangular cross section conforming to the shapes of the magnet holders 42. A material similar to that of the magnets 24 according to the first embodiment may be used for the magnets 44.

The cogging torque and magnetic flux density of the motor using the rotor 46 described above were investigated by simulation analysis as in the first embodiment. The schematic structure of the stator is configured to be identical to that of the first embodiment. Examples of parameters in the rotor core 40 and the rotor 46 in FIG. 15A and FIG. 15B will be given hereinafter.

The inner diameter R1 of the stator core is 15.0 mm and the outer diameter R2 is 22.8 mm. The distance D1 from the center to the outer circumference of the magnets 44 is 14.2 mm, and the distance D2 from the center to the inner circumference of the magnets 44 is 10.1 mm. The outer diameter R5 of the rotor core 40 in the IPM part is 14.7 mm. The circumferential width W1 of the teeth 26 of the stator core 28 is 4.4 mm. The thickness of the stator core 28, the magnets 44, and the rotor core 40 in the axial direction is 4 mm. Unlike the rotor 12 according to the first embodiment, the rotor 46 according to the second embodiment is not provided with a back yoke but may be provided with a back yoke. Also, the rotor core 40 may be a laminated core of a thickness substantially identical to that of the stator core 28.

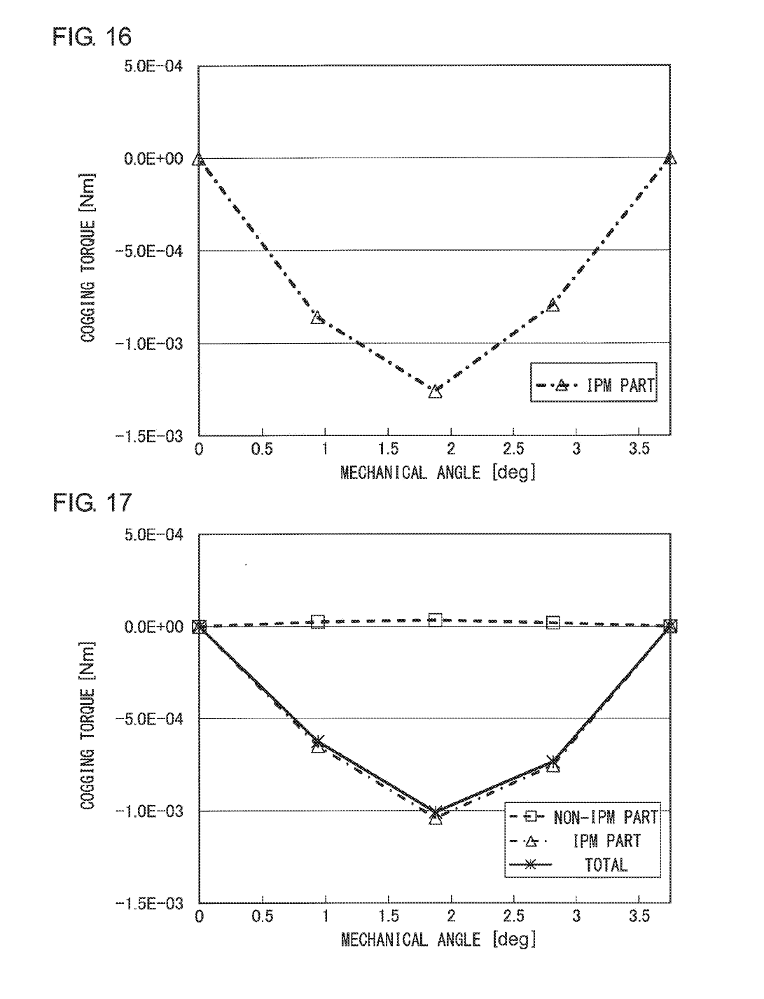

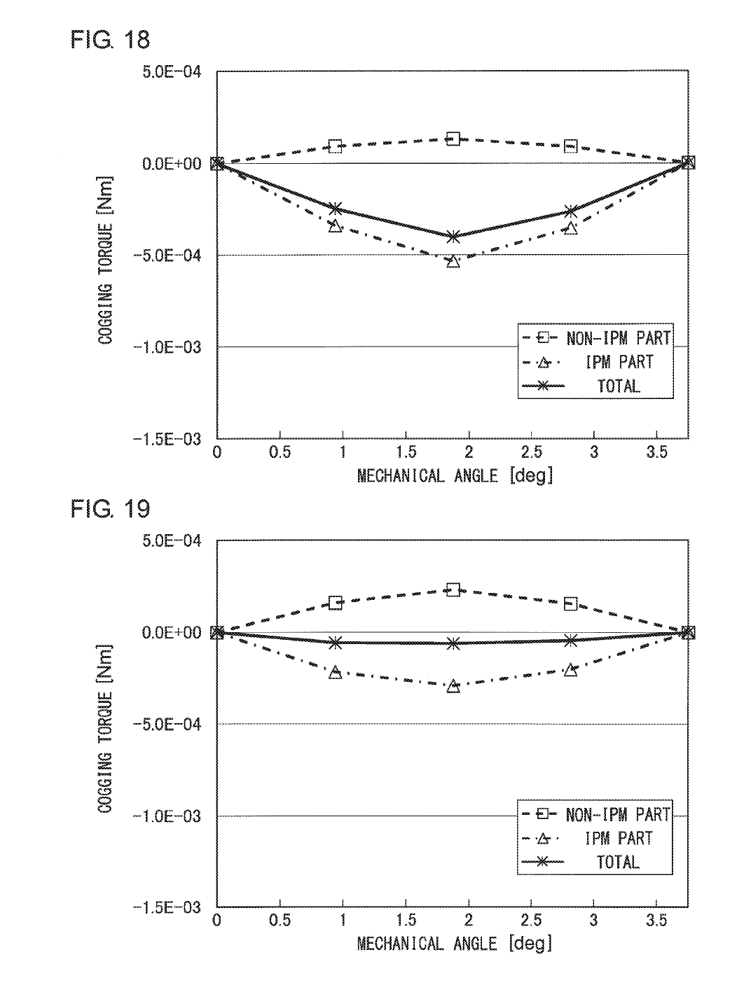

FIG. 16 is a graph showing a relationship between the mechanical angle and the cogging torque occurring when the rotor is composed only of the IPM part in the second embodiment. FIG. 17 is a graph showing a relationship between the mechanical angle and the cogging torque occurring when the IPM part is of a thickness 75% the total thickness of the rotor. FIG. 18 is a graph showing a relationship between the mechanical angle and the cogging torque occurring when the IPM part is of a thickness 50% the total thickness of the rotor. FIG. 19 is a graph showing a relationship between the mechanical angle and the cogging torque occurring when the IPM part is of a thickness 25% the total thickness of the rotor. In all of the cases where the non-IPM part is provided, the cogging torque generated by the IPM part is reduced. The cogging torque generated by the IPM part and the cogging torque generated by the non-IPM part are in opposite phase so that the total cogging torque in the rotor is reduced. In particular, it is preferable that the IPM part be of a thickness 25%-75% the total thickness of the rotor.

### Third Embodiment

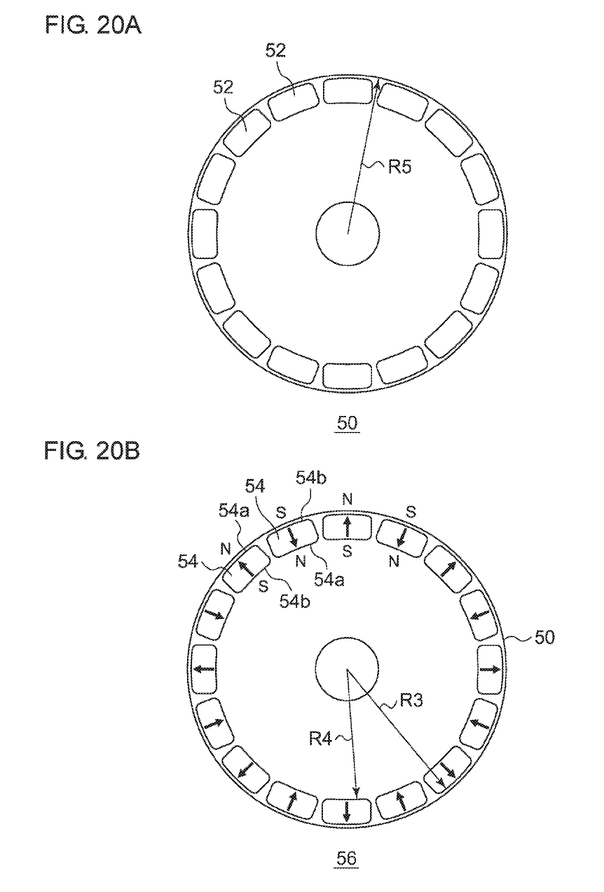

FIG. 20a is a top view of the rotor core according to the third embodiment, and FIG. 20B is a top view schematically showing that the magnets are supported by the holders of the rotor core shown in FIG. 20A. A rotor core 50 is manufactured similarly as the rotor core 22. Magnet holders 52 are radially formed around the rotating shaft of the rotor core 50.

As shown in FIG. 20B, each of magnets 54 has an N pole or an S pole on a radial main surface 54a (54b). The magnets 54 are accommodated in the magnet holders 52 such that N poles and S poles alternate on the outer circumferential surface of the magnets 54. In other words, magnets of two types that differ in the orientation of the magnetic poles are alternately arranged in the circumferential direction. Consequently, a rotor 56 according to the embodiment functions as a magnet having a total of 16 poles including 8 N poles and 8 S poles alternately arranged on the outer circumference of the rotor 56. The magnets 54 are columnar members having a substantially trapezoidal cross section conforming to the shapes of the magnet holders 52. A material similar to that of the magnets 24 according to the first embodiment may be use for the magnets 54.

The cogging torque and magnetic flux density of the motor using the rotor 56 described above were investigated by simulation analysis as in the first embodiment. The schematic structure of the stator is configured to be identical to that of the first embodiment. Examples of parameters in the rotor core 50 and the rotor 56 in FIG. 20A and FIG. 20B will be given hereinafter.

The inner diameter R1 of the stator core is 14.0 mm and the outer diameter R2 is 22.8 mm. The distance R3 from the center to the outer circumference of the magnets 54 is 13.4 mm, and the distance R4 (not shown; outer diameter R4 of the back yoke) from the center to the inner circumference of the magnets 54 is 11.5 mm. The outer diameter R5 of the rotor core 40 in the IPM part is 13.6 mm. The circumferential width W1 of the teeth 26 of the stator core 28 is 4.6 mm. The thickness of the stator core 28, the magnets 54, and the rotor 56 in the axial direction is 4 mm. Like the rotor 12 according to the first embodiment, the rotor 56 according to the third embodiment is provided with a back yoke but may not be provided with a back yoke. Also, the rotor core 50 may be a laminated core of a thickness substantially identical to that of the stator core 28.

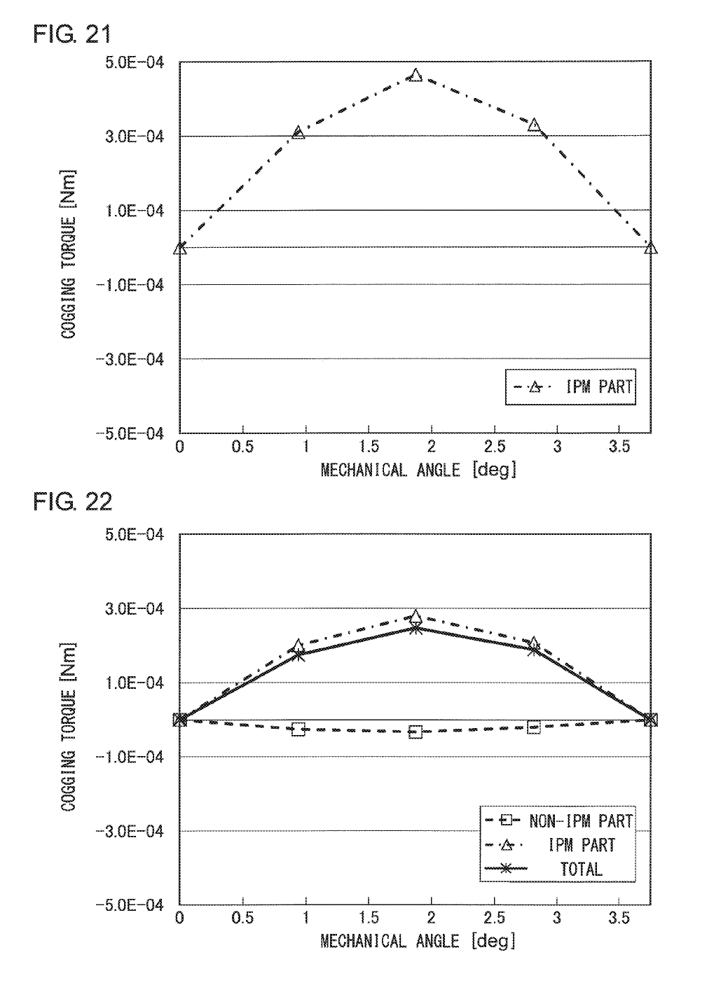

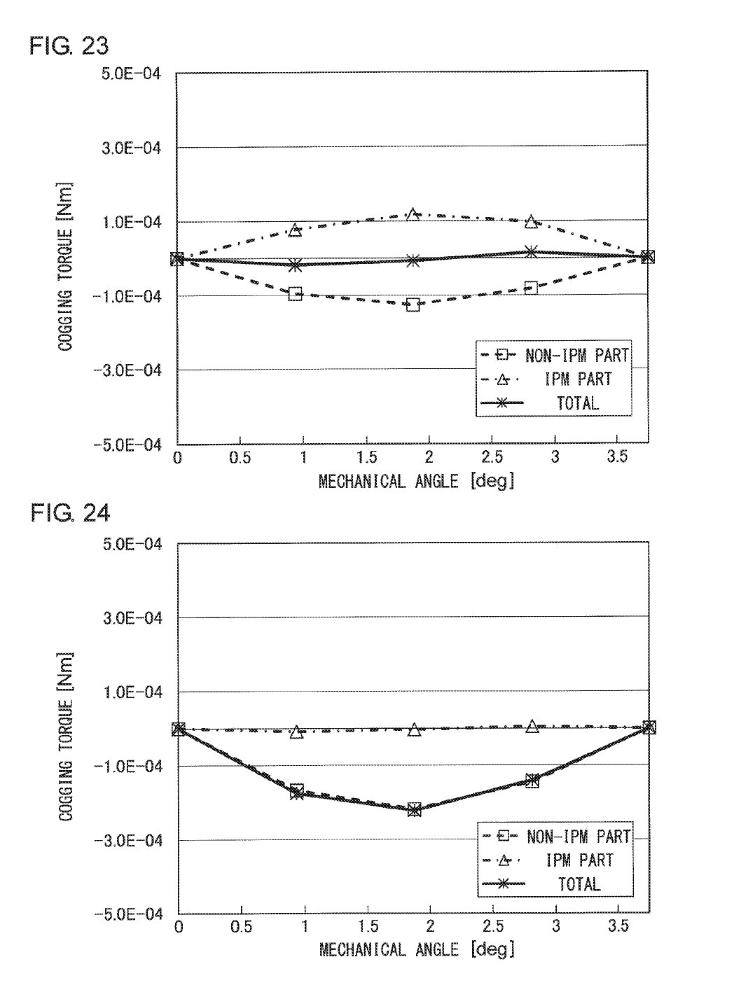

FIG. 21 is a graph showing a relationship between the mechanical angle and the cogging torque occurring when the rotor is composed only of the IPM part in the third embodiment. FIG. 22 is a graph showing a relationship between the mechanical angle and the cogging torque occurring when the IPM part is of a thickness 75% the total thickness of the rotor. FIG. 23 is a graph showing a relationship between the mechanical angle and the cogging torque occurring when the IPM part is of a thickness 50% the total thickness of the rotor. FIG. 24 is a graph showing a relationship between the mechanical angle and the cogging torque occurring when the IPM part is of a thickness 25% the total thickness of the rotor. In all of the cases where the non-IPM part is reduced. In the case where the IPM part is of a thickness 75% or 50% the total thickness of the rotor, the cogging torque generated by the IPM part and the cogging torque generated by the non-IPM part are in opposite phase so that the total cogging torque in the rotor is reduced. In particular, it is preferable that the IPM part is of a thickness 25%-75% the total thickness of the rotor.

### Fourth Embodiment

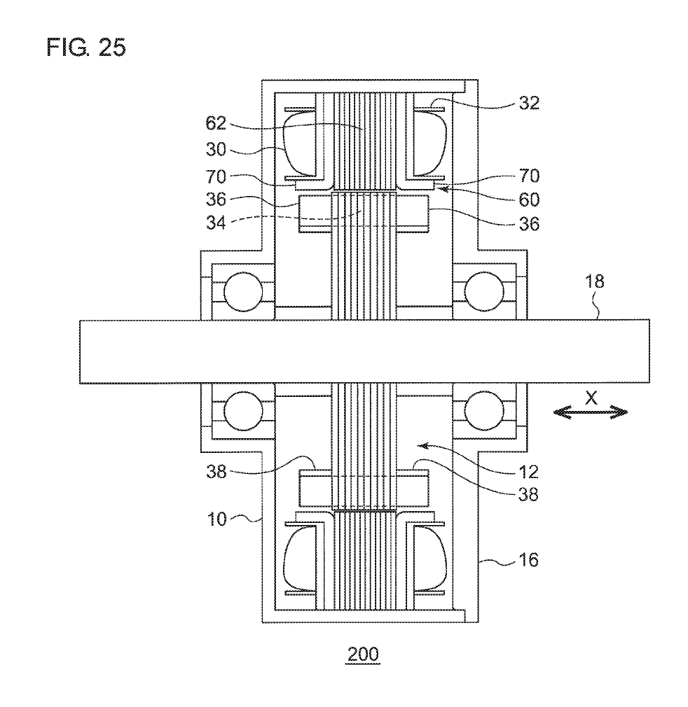

FIG. 25 is a sectional view of the motor according to the fourth embodiment. The schematic structure of a motor 200 according to the fourth embodiment is largely similar to that of the motor 100 according to the first embodiment and a main difference consists in the shape of the stator or core 62 of the stator 60.

In an annular stator core 62 shown in FIG. 25, the area of the stator core 62 that faces the outer circumferential surface of the rotor 12 is increased by bending, in the axial direction X, the ends of a plate-shaped stator yoke 70, that faces the rotating shaft 18, located on the respective outermost surfaces on of the stator core 62. The inner circumferential surface of the stator yoke 70 thus bent faces the outer circumferential surface of the projection 36 of the rotor 12. The inner circumferential surface of the center of the stator core 62 faces the outer circumferential surface of the supported part 34. This can reduce the thickness of the stator 60 without reducing the valid magnetic flux between the rotor and the stator.

### Fifth Embodiment

The description of the above embodiments is directed to cases where the IPM part is located at the center in the direction of thickness of the rotor. However, the IPM part should not necessarily be at the center. For example, the non-IPM part may be located at the center in the direction of thickness of the rotor and the IPM part may be located at the ends. In the rotor 12 according to the first embodiment, the area at the axial center representing about 50% of the total is occupied by the IPM part and the areas on both sides of the IPM representing about 25% each are occupied by the non-IPM parts. Meanwhile, in the rotor according to the fifth embodiment, the the area at the axial center representing about 75% of the total is occupied by the non-IPM part and the areas sandwiching the non-IPM and representing about 12.5% each are occupied by the IPM parts. A simulation as described above was conducted, ensuring that the other features are identical to those of the motor 100 according to the first embodiment.

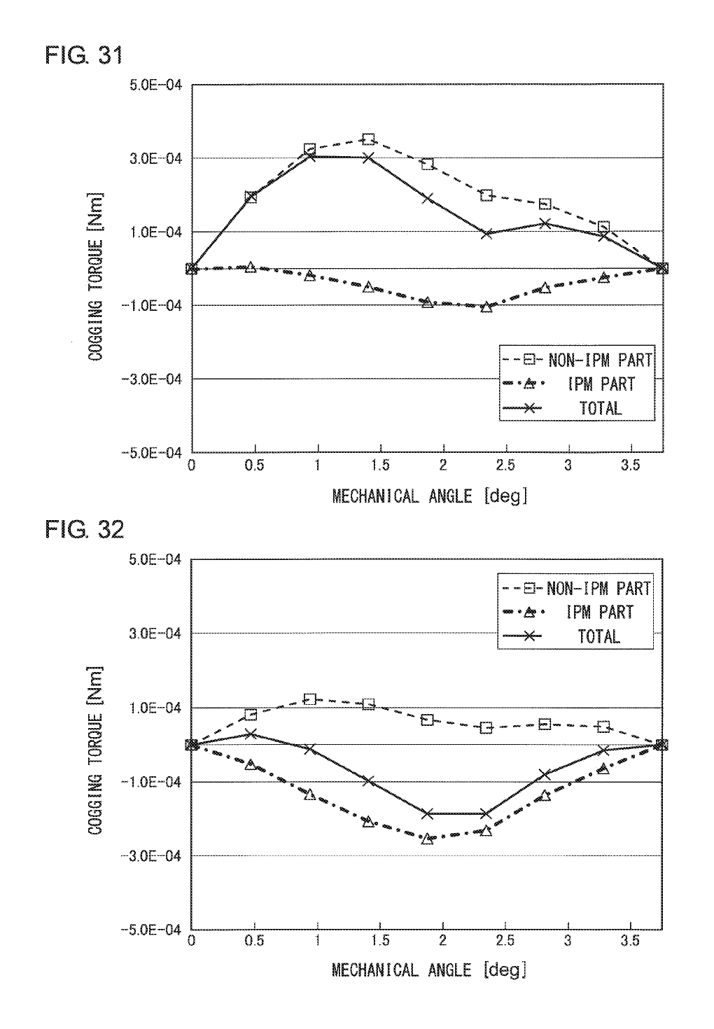

FIG. 31 is a graph showing a relationship between the mechanical angle and the cogging torque in the motor according to the fifth embodiment. The motor according to the fifth embodiment is largely similar to the motor 100 according to the first embodiment and a main difference consists in the position where the IPM part is provided. As shown in FIG. 31, the cogging torque characteristics of the non-IPM part are characterized by a generally larger cogging torque as compared to the reference cogging torque characteristics shown in FIG. 7. Meanwhile, the phase of the cogging torque in the IPM part is shifted with respect to that of the non-IPM part. For this reason, totaling the cogging torque generated in the non-IPM part and the cogging torque generated in the IPM part, the absolute value (maximum peak value) of the total cogging torque is smaller than the cogging torque generated in the non-IPM part.

### Sixth Embodiment

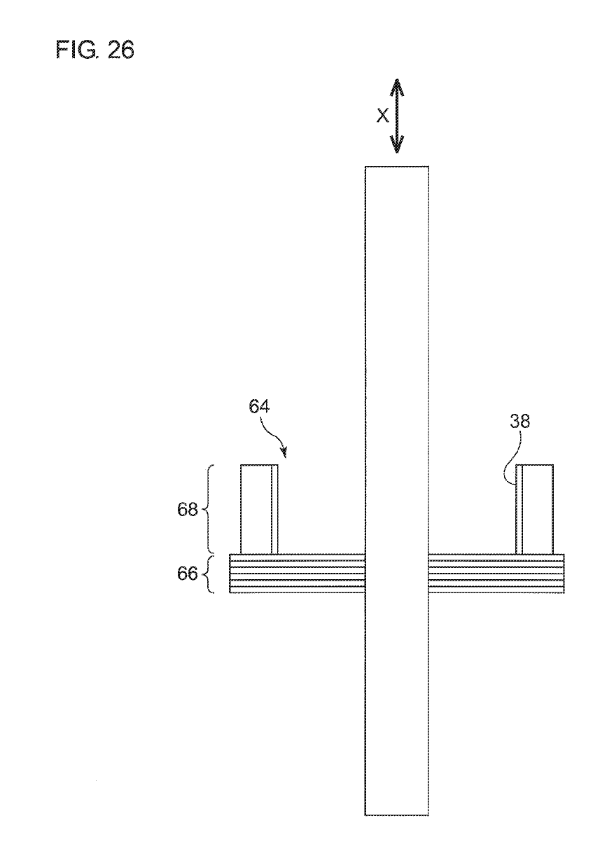

FIG. 26 is a sectional view showing the schematic structure of the rotor according to the sixth embodiment. As Shown in FIG. 26, an IPM part 66 is provided toward one end face of a rotor 64 in the axial direction X, and a non-IPM part 68 is provided toward the other end face of the rotor 64 in the axial direction X.

More specifically, in the rotor 64, the area toward one axial end representing about 70% of the total is occupied by the non-IPM part 68 and the area toward the other axial end representing about 30% is occupied by the IPM part 66. A simulation an described above was conducted, ensuring that the other features are identical to those of the motor 100 according to the first embodiment.

FIG. 32 is a graph showing a relationship between the mechanical angle and the cogging torque in the motor according to the sixth embodiment. The motor according to the sixth embodiment is largely similar to the motor 100 according to the first embodiment and a main difference consists in the position where the IPM part is provided. As shown in FIG. 32, the cogging torque characteristics of the non-IPM part 68 are characterized by a generally smaller cogging torque as compared to the reference cogging torque characteristics shown in FIG. 7. In addition, the phase of the cogging torque in the IPM part 66 is shifted with respect to that of the non-IPM part 68. For this reason, totaling the cogging torque generated in the non-IPM part 68 and the cogging torque generated in the IPM part 66, the absolute value (maximum peak value) of the total cogging torque is smaller than the cogging torque generated in the non-IPM part 68. It is demonstrated that a similar advantage is obtained so long as the area at the other axial end representing about 30-40% of the total is occupied by the IPM part 66. The rotor or motor provided with the rotor 64 configured as described above can also exhibit the above-described advantage of reducing the cogging torque.

### Seventh Embodiment

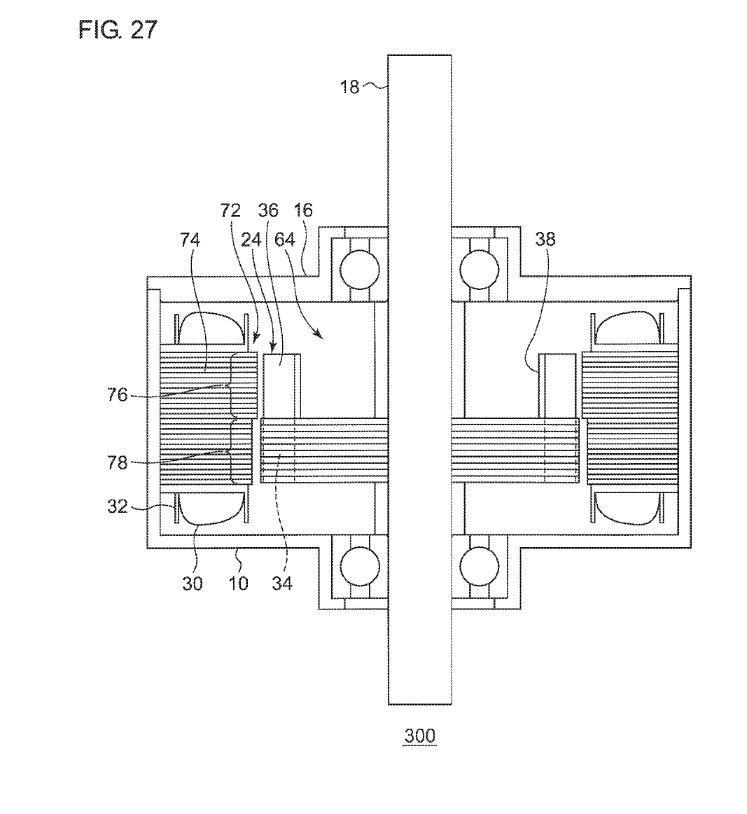

FIG. 27 is a sectional view of the motor according to the seventh embodiment. A motor 300 according to the seventh embodiment is provided with a rotor 64 and a stator 72. A stator core 74 forming the stator 72 is configured such that the inner diameter at the end of the teeth in an area 76 facing the projection 36 of the rotor 64 is smaller than the inner diameter at the end of the teeth in an area 78 facing the supported part 34. This can reduce the distance between the projection 36 of the magnet 24 and the stator core 74 and further improve the valid magnetic flux between the rotor and the stator.

### Eighth Embodiment

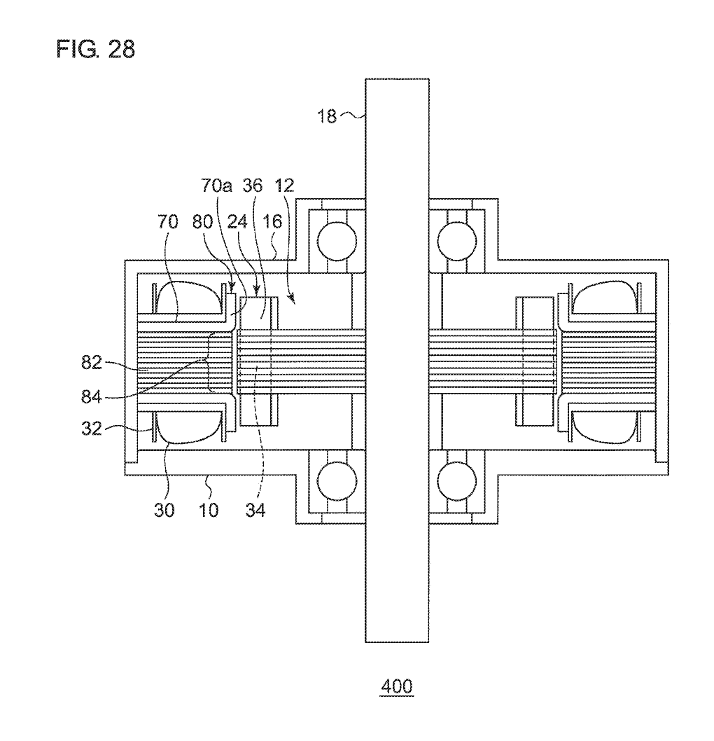

FIG. 28 is a sectional view of the motor according to the eight embodiment. The structure of a motor 400 according to the eighth embodiment is substantially identical to that of the motor 200 according to the fourth embodiment but differs in the structure of a stator 80. A stator core 82 forming the stator 80 is configured such that the inner diameter at a bent inner edge part 70a of the stator yoke 70 facing the projection 36 of the rotor 12 is smaller than the inner diameter at the end of the teeth in an area 84 facing the supported part 34. This can reduce the distance between the projection 36 of the magnet 24 and the stator core 82 and further improve the valid magnetic flux between the rotor and the stator.

In the embodiments described above, support of the magnets is implemented by forming the magnet holder in the rotor core and accommodating the supported part of the magnet in the holder. Alternatively, a magnet supporter may be formed by forming a convex part in the rotor core and the magnet may be supported by providing the magnet with a holder in which the convex part is accommodated.

### Variation

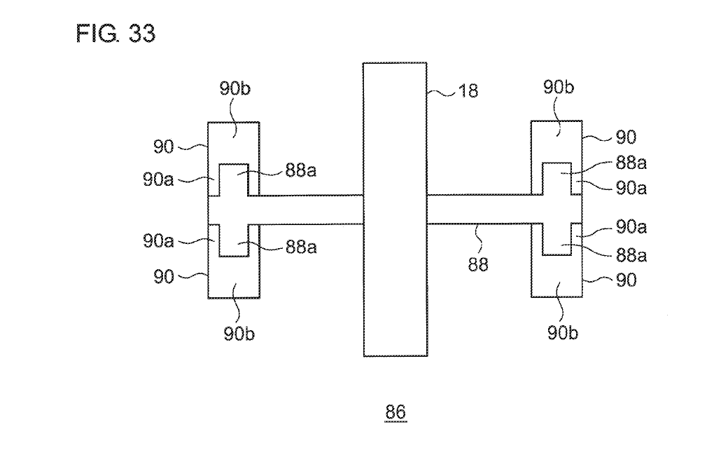

FIG. 33 is a schematic sectional view of the rotor according to a variation. A rotor 86 shown in FIG. 33 includes a disc-shaped rotor core 88 in which the rotating shaft 18 is fixed at the center, and magnets 90 supported by convex parts 88a of the rotor core 88. A plurality of convex parts 88a of the rotor core 88 are annularly provided in both surfaces of the disc-shaped rotor core 88. In other words, the rotor core 88 includes the convex parts 88a as a plurality of magnet supporters radially formed around the rotating shaft 18. Meanwhile, each of magnets 90 includes a supported part 90a supported by the convex part 88a and a projection 90b projecting from the convex part 88a in the axial direction of the rotating shaft 18.

As in the embodiments described above, the rotor core 88 and the plurality of annularly arranged supported parts 90a of the rotor 86 configured as described above form a first generation part that generates a cogging torque of a first waveform, and the plurality of annularly arranged projections 90b form a second generation part that generates a cogging torque that differs in phase from the cogging torque of the first waveform.

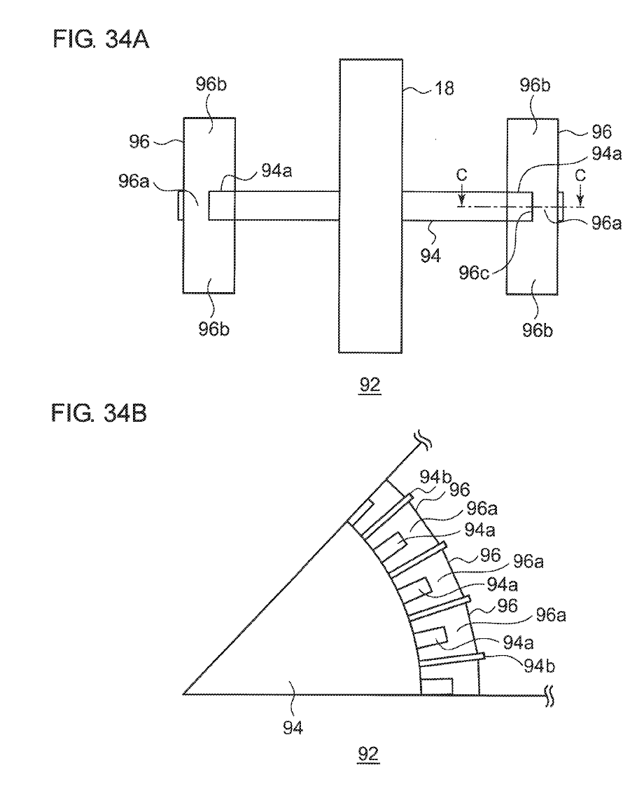

FIG. 34A is a schematic sectional view of the rotor according to another variation, and FIG. 34B is a sectional view along C-C in FIG. 34A. A rotor 92 shown in FIGS. 34A and 34B includes a disc-shaped rotor core 94 in which the rotating shaft is fixed at the center, and magnets 96 supported by convex parts 94a of the rotor core 94. A plurality of convex parts 94a of the rotor core 94 are provided on the outer circumference of the disc-shaped rotor core 94 at intervals in the circumferential direction. In other words, the rotor core 94 includes the convex parts 94a as a plurality of magnet supporters radially formed around the rotating shaft 18. Further, a partition 94b extending radially from the outer circumference of the rotor core 94 is provided between adjacent magnets 96. Meanwhile, each of magnets 96 includes a supported part 96a supported by the convex part 94a and a projection 96b projecting from the supported part 96a in the axial direction of the rotating shaft 18. By fitting the convex part 94a to a concave part 96c of the magnet 96, the magnets 96 are fixed on the outer circumference of the rotor core 94. The convex part 94a and the concave part 96c may have various shapes. For example, the concave part 96c may be provided as a slit. Alternatively, the shape of the end of the convex part 94a may be designed to ensure that the magnet is not dislocated by a centrifugal force while the color is rotated.

As in the embodiments described above, the rotor core 94 and the plurality of annularly arranged supported parts 96a of the rotor 92 configured as described above form a first generation part that generates a cogging torque of a first waveform, and the plurality of annularly arranged projections 96b form a second generation part that generates a second cogging torque that differs in phase from the cogging torque of the first waveform.

The rotor according to the first embodiment is configured with a Halbach array of a plurality of magnets. Alternatively, the rotor may be provided with a polar anisotropic ring magnet and an elongated magnetic ring smaller in width than the ring magnet may be provided on the outer circumference of the ring manner.

The embodiments of the present invention are not limited to those described above and appropriate combinations or replacements of the features of the embodiments are also encompassed by the present invention. The embodiments may be modified by way of combinations, rearranging of the processing sequence, design changes, etc., based on the knowledge of a skilled person, and such modifications are also within the scope of the present invention.

1. A motor comprising:
a tube stator including a stator core having a plurality of teeth, and wirings wound around the plurality of teeth respectively; and
a rotor provided at the center of the stator, wherein the rotor includes:
a rotor core; and
one or more magnets, wherein
the rotor core includes magnet supporters radially formed around a rotating shaft,
the magnet includes a supported part supported by the magnet supporter and a projection projecting from the magnet supporter in an axial direction of the rotating shaft,
the rotor core and the plurality of supported parts arranged annularly form a first generation part that generates a cogging torque of a first waveform,
the projections are arranged annularly and form a second generation part that generates a second cogging torque that differs in phase from the cogging torque of the first waveform, and
the stator core is configured to face the supported part and the projection of the magnet in a radial direction of the stator.

2. The motor according to claim 1, wherein:
the magnet includes a first projection that projects from the magnet supporter in one axial direction of the rotating shaft, and a second projection that projects from the magnet supporter in the other axial direction of the rotating shaft.

3. The motor according to claim 1, wherein:
the magnet is provided with the supported part at one end of the magnet in an axial direction of the rotating shaft.

4. The motor according to claim 1, wherein:
the magnet is provided with two supported parts spaced apart from each other at respective ends of the magnet in an axial direction of the rotating shaft,
the projection is provided between the two supported parts.

5. The motor according to claim 1, wherein:
given that an axial length of the magnet is denoted by L and an axial thickness of the magnet supporter is denoted by T, the following expression (1) is met,
0.2<T/L<O. 75 (1).

6. The motor according to claim 1, wherein:
a plurality of magnets are provided, and
the plurality of magnets are annularly arranged in a Halbach array.

7. The motor according to claim 1, wherein:
an incision that communicates the magnet supporter with a space outside is formed in the outer circumference of the rotor core.

8. A motor comprising:
a tube stator including a stator core having a plurality of teeth, and wirings wound around the plurality of teeth respectively; and
a rotor provided at the center of the stator, wherein the rotor includes:
a rotor core;
a polar anisotropic ring magnet provided on the outer circumference of the rotor core; and
a magnetic ring provided on the outer circumference of the ring magnet and smaller in width in an axial direction than the ring magnet, wherein
an area in the rotor in which the rotor core, the ring magnet, and the magnetic ring overlap in a radial direction of the rotor core form a first generation part that generates a cogging torque of a first waveform, and
an area in the rotor in which the ring magnet and the magnetic ring do not overlap in a radial direction of the rotor core form a second generation part that generates a second cogging torque that differs in phase from the cogging torque of the first waveform, and the stator core is configured to face the first generation part and the second generation part in a radial direction of the stator.

9. The motor according to claim 1, wherein:
a stator core is configured such that an inner diameter of an area facing the projection is smaller than an inner diameter of an area facing the supported part.
